(19) United States
(12) Patent Application Publication
(10) Pub. No.: US 2025/0031905 A1
(43) Pub. Date: Jan. 30, 2025

(54) Cast Iron Cookware With Integrated Heat Diffuser

(71) Applicant: Steven M. Bogush, Selinsgrove, PA (US)

(72) Inventor: Steven M. Bogush, Selinsgrove, PA (US)

(21) Appl. No.: 18/595,774

(22) Filed: Mar. 5, 2024

Related U.S. Application Data
(60) Provisional application No. 63/528,994, filed on Jul. 26, 2023.

(51) Int. Cl. A47J 37/10; A47J 36/02

(52) U.S. Cl. CPC A47J 37/108; A47J 36/02

(57) ABSTRACT

It is proposed to utilize a heat diffuser formed of a material with a relatively high level of thermal diffusivity in combination with cast iron cookware to improve the evenness of the cooking surface temperature. In particular, the heat diffuser is releasably attached to the exterior of the cookware's bottom surface so as to rest against the cooking element when the cookware is in use. The heat diffuser is formed to exhibit a diameter similar to the cooking surface of the cast iron cookware and is able to quickly transport a portion of the created thermal energy of the cooking element outward toward the outer periphery of the cooking surface. The inclusion of the heat diffuser thus provides a more uniform cooking area in cast iron cookware and functions to significantly reduce (if not eliminate) the “hot spots” as found in conventional cast iron cookware.

### CROSS-REFERENCE TO RELATED APPLICATIONS

This application claims priority from U.S. Provisional Application No. 63/528,994 filed Jul. 26, 2023 and herein incorporated by reference.

### TECHNICAL FIELD

The present invention is directed to cast iron cookware and, more particularly, to the utilization of a heat diffuser in combination with the cookware to minimize the presence of hot spots on the cooking surface and reducing the nonuniformity of the cooking surface temperature.

### BACKGROUND OF THE INVENTION

Cast iron pans have been the gold standard of cookware for hundreds of years, and are still used daily by millions. In the past, these cast iron pans were primarily used over an open fire or a coal-fired (or wood-fired) cookstove where the heat source was relatively spaced out over a large area. Today, cast iron pans are just as likely to be used with conventional household stoves. Unfortunately, today's household stoves are formed to include individual, confined heating elements (burners) where the heat is extremely concentrated. The inherent, relatively low thermal diffusivity of cast iron results in cast iron pans (especially larger-sized pans exhibiting “hot spots” in the center of the pan (that is, the region directly over the burner) which causes uneven cooking—even burning—of the food that is being prepared.

While typically used in the form of frying pans, other cast iron cookware may comprise a skillet, griddle, or the like. Whatever the form, the uneven heating of cast iron material remains a concern when using cast iron cookware in today's kitchens.

### SUMMARY OF THE INVENTION

The need remaining in the art is addressed by the present invention, which relates to cast iron cookware and, more particularly, to the utilization of an external, removable heat diffuser element in combination with the conventional cookware.

In accordance with the principles of the present invention, it is proposed to utilize a heat diffuser formed of a material with a relatively high level of thermal diffusivity (as compared to the cast iron). In particular, the heat diffuser is disposed between the exterior of the cookware's bottom surface and the cooking element. The heat diffuser is formed to exhibit a diameter similar to the cooking surface of the cast iron pan and is able to quickly transport a portion of the created thermal energy of the cooking element outward toward the outer periphery of the cooking surface. The inclusion of the heat diffuser thus provides a more uniform cooking area in cast iron cookware and functions to significantly reduce (if not eliminate) the “hot spots” as found in conventional cast iron pans.

In one example embodiment of the present invention, the heat diffuser may be formed as a disk-shaped element that is removably attached to the outer surface of the cast iron pan, allowing for the “original” cast iron frying pan to be used over an open fire or old-fashioned cookstove (with an uniformly-heated cooking surface), if desired.

A heat diffuser as used with a cast iron pan may use more than one high diffusivity material and in one configuration may have a central region of a first thermal diffusivity, surrounded by a periphery of another material with a second, different thermal diffusivity. In one example, the central region may exhibit the highest thermal diffusivity (e.g., copper), surrounded by a ring of a material such as aluminum, which has a thermal diffusivity somewhat less than copper, but at least an order of magnitude greater than cast iron.

An exemplary embodiment of the present invention may take the form of cookware comprising a combination of a cast iron cooking element and an associated heat diffuser element. The cast iron cooking element (e.g., pan, skillet, griddle, or the like) comprises a cast iron cooking surface of a defined surface area geometry, which is defined as having an inner, cooking side and an outer, heating side. Cast iron is known to have a rate of thermal diffusivity of about 23 mm²/s. The cooking element further comprises a releasable attachment mechanism disposed on the outer, heating side of the cast iron cooking surface. The heat diffuser element is coupled to the outer, heating side of the cast iron cooking surface by the releasable attachment mechanism, where the heat diffuser element is configured to exhibit a topology similar to the outer, heating side of the cast iron cooking surface and formed of a composition comprising a rate of thermal diffusivity greater than cast iron.

Other and further aspects and embodiments of the present invention will become apparent during the course of the following discussion and by reference to the accompanying drawings.

### BRIEF DESCRIPTION OF THE DRAWINGS

Referring now to the drawings,

FIG. 1 is an isometric view of a typical cast iron pan;

FIG. 2 is a side view of cast iron pan of FIG. 1, particularly illustrating a set of releasable attachment mechanisms (here, nubs) formed on the bottom surface of the pan;

FIG. 3 is a top view of an exemplary heat diffuser element formed in accordance with the principles of the present invention;

FIG. 4 is a side view of the exemplary heat diffuser element of FIG. 3;

FIG. 5 is a bottom view of a cast iron pan with a heat diffuser element initially placed such that cut-outs on the diffuser element are positioned to expose the attachment mechanisms on the cast iron pan;

FIG. 6 is a similar view as shown in FIG. 5, in this case with the heat diffuser element rotated and “locked” in place with respect to the bottom surface of the cast iron pan;

FIG. 7 illustrates an example of a heat diffuser element formed of two different materials, each having a higher thermal diffusivity than cast iron;

FIG. 8 illustrates an alternative embodiment of a heat diffuser element formed in accordance with the present invention;

FIG. 9 is an isometric view of a portion of the heat diffuser element of FIG. 8;

FIG. 10 shows the heat diffuser element of FIG. 8 in place over bottom surface of a cast iron pan;

FIG. 11 illustrates the same combination as shown in FIG. 10, in this case showing a final, “locked” position of the heat diffuser element with respect to the bottom surface of the cast iron pan;

FIG. 12 illustrates a cast iron griddle and associated heat diffuser element formed in accordance with the present invention;

FIG. 13 illustrates the heat diffuser element of FIG. 12 in position on the bottom surface of the griddle;

FIG. 14 is a side view of the arrangement of FIG. 13, illustrating in particular the alignment of the attachment mechanisms between the bottom surface of the cast iron griddle and the heat diffuser element;

FIG. 15 is an exploded, isometric view of another configuration of a heat diffuser element suitable and cast iron griddle;

FIG. 16 depicts the heat diffuser element of FIG. 15 as in aligned position with L-shaped nubs on the bottom surface of a cast iron griddle; and

FIG. 17 shows the heat diffuser element of FIG. 16 as rotated into a “locked” (yet releasable) position with respect to the bottom side of the cast iron griddle.

### DETAILED DESCRIPTION

While the details of the inventive heat diffuser are primarily described in association with a cast iron frying pan, it is to be understood that the disclosed heat diffuser is applicable for use with any type of cast iron cookware, including but not limited to, frying pans, skillets, sauté pans, griddles, and the like. At times, the phrase “cast iron pan” is used and is also intended to cover all various types of cookware.

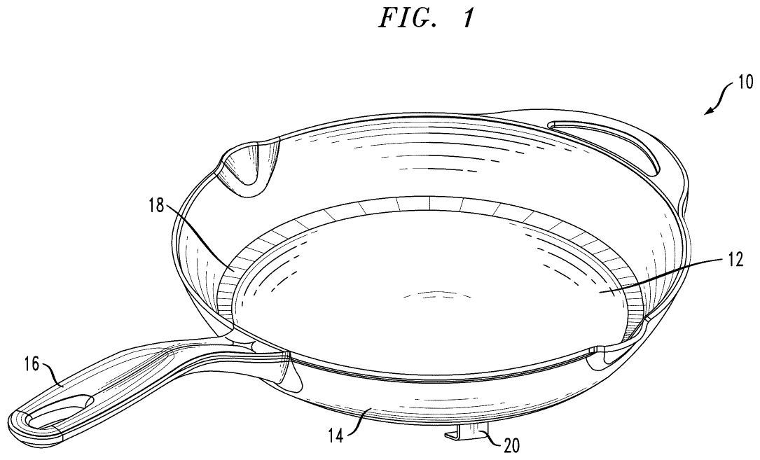

FIG. 1 is an isometric view of a typical cast iron pan 10, including a cooking surface 12 and sidewall 14 (which may be inclined outward with respect to cooking surface 12). A handle 16 is included as well. One reason for the popularity of cast iron as the composition for cookware is its rate of thermal diffusivity, which is about 23 mm²/s. In heat transfer analysis, thermal diffusivity is defined as the thermal conductivity of a material divided by its density and specific heat capacity at constant pressure. Said another way, thermal diffusivity measures the rate of transfer of heat energy from a “hot” end of a material to the opposing “cold” end.

Also shown in FIG. 1 is an exemplary cast iron releasable attachment mechanism 20 that is affixed to the bottom of cooking surface 12 along a portion of its periphery 18 (indeed, mechanism 20 may comprise part of the cookware as it is cast). As will be described in detail below, an exemplary cast iron pan of the present invention is formed to include a plurality of mechanisms 20 disposed around the periphery of bottom surface 12B. Referred to at times hereafter as an “L-shaped nub” or simply “nub”, attachment mechanism 20 engages with the surface of an associated heat diffuser element in a manner that holds a removable heat diffuser element in place during use of the cookware.

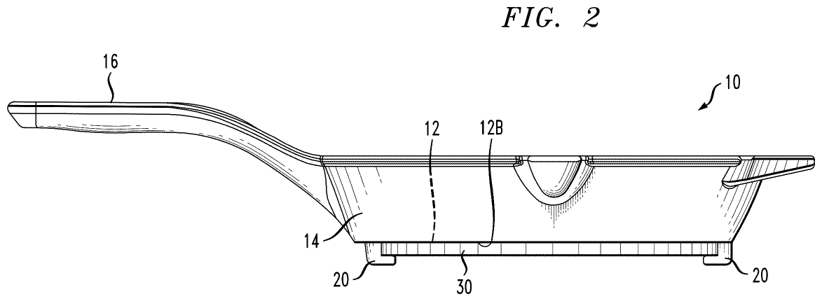

In particular, FIG. 2 is a side view of cast iron pan 10, clearly showing an exemplary pair of L-shaped nubs 20-1 and 20-2 that is used to support a removable heat diffuser element 30 in its position adjacent to underside 12B of cooking surface 12. At times “underside 12B” may be referred to as “bottom surface 12B” or “outer, heating surface 12B”.

In accordance with the principles of the present invention, heat diffuser element 30 is made of a material exhibiting a relatively high rate of thermal diffusivity (i.e., higher than that of cast iron) to effectuate the movement of thermal energy from the portion of the pan directly over a burner element toward the outer periphery of the pan. Materials such as copper (with a diffusivity of 111 mm²/s), aluminum (diffusivity of 97 mm²/s), and carbon (with a diffusivity of 216.5 mm²/s)—including carbon composite materials—are examples of materials that may be used for the heat diffuser element inasmuch as their thermal diffusivity rates are at least an order of magnitude greater than cast iron.

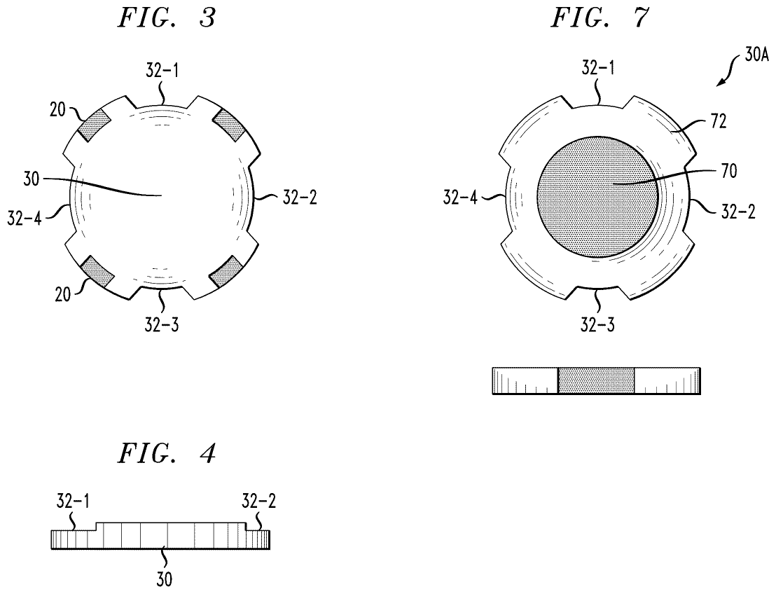

FIGS. 3 and 4 illustrate an exemplary heat diffuser element 30, where FIG. 3 is a top view and FIG. 4 is a side view. In this exemplary arrangement, heat diffuser element 30 is formed to include a set of cut-outs 32. In accordance with the principles of the present invention, cut-outs 32 are located around the outer periphery of heat diffuser element 30 such that they will align with the set of L-shaped nubs 20 (see FIG. 2) when heat diffuser element 30 is positioned against bottom side 12B of cast iron pan 10. Once aligned, heat diffuser element 30 may be rotated with respect to pan 10 so that cut-outs 32 are rotated away from nubs 20, which now engage with heat diffuser element 30 in the manner shown in FIG. 2.

FIG. 5 is a bottom view of pan 10 with heat diffuser element 30 initially placed such that cut-outs 32 are positioned to expose nubs 20. Once positioned, heat diffuser element 30 is rotated (as indicated by the arrow in FIG. 5), resulting in the configuration of FIG. 6, which shows heat diffuser element 30 “locked” in place with respect to bottom surface 12B of cast iron pan 10. The attachment between cast iron pan 10 and heat diffuser element 30 is considered as “releasable” since element 30 may be removed by rotating it with respect to bottom surface 12B until nubs 20 are again exposed.

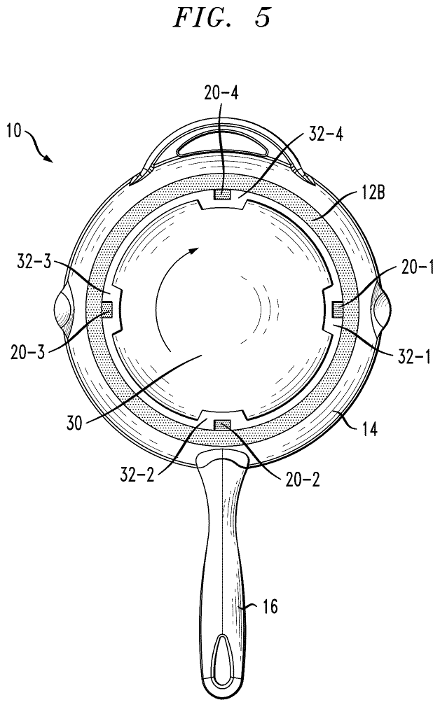

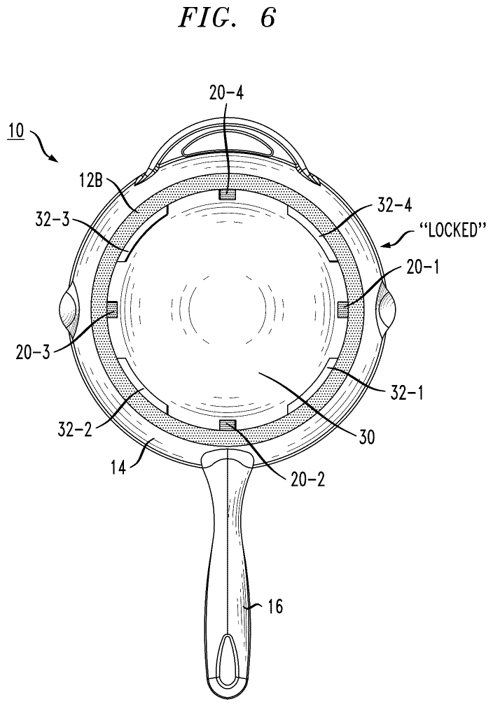

FIG. 7 illustrates an example of a heat diffuser element formed of two different materials, each having a higher thermal diffusivity than cast iron. In particular, a heat diffuser element 30A is shown that comprises a central region 70 formed of a first material exhibiting a first thermal diffusivity value and a surrounding ring 72 of a second material exhibiting a second thermal diffusivity value. Central region 70 may exhibit a higher thermal diffusivity than surrounding ring 72 as to more quickly transport the heat outward from the central source of heat. Indeed, this embodiment may be a preferred alternative when used with a gas burner that has a concentrated heat source in the form of a flame. In one example, central region 70 may be formed of copper (with a thermal diffusivity of about 111 mm²/s, with a surrounding ring 72 formed of aluminum (with a thermal diffusivity of about 97 mm²/s).

FIGS. 8-11 illustrate another configuration using L-shaped nubs as a releasable mechanism for attaching a heat diffuser element to the outer, heating side (bottom) surface of a cast iron pan. FIG. 8 illustrates a heat diffuser element 30B (again in the form of a disk) which is formed to include a set of notched attachment areas 34, with each including a cut-out 36 (similar to cut-out 32 described above). Here, cut-outs 36 are sized to exhibit a width S slightly greater than the width of a nub as formed on the pan. Additionally, adjacent to each cut-out 36 is an extended ledge 38 that is notched out of the total thickness of heat diffuser element 30B. Ledge 38 is shown as terminating at a vertical wall 38W. When used in combination with the nubs on a bottom surface of a cast iron frying pan (such as L-shaped nubs 20 discussed above), heat diffuser element 30B is placed over the bottom surface of the pan so that the nubs are exposed in cut-outs 36 (similar as described above), with element 30B rotated such that the nub moves onto ledge 38 and abuts against vertical wall 38W.

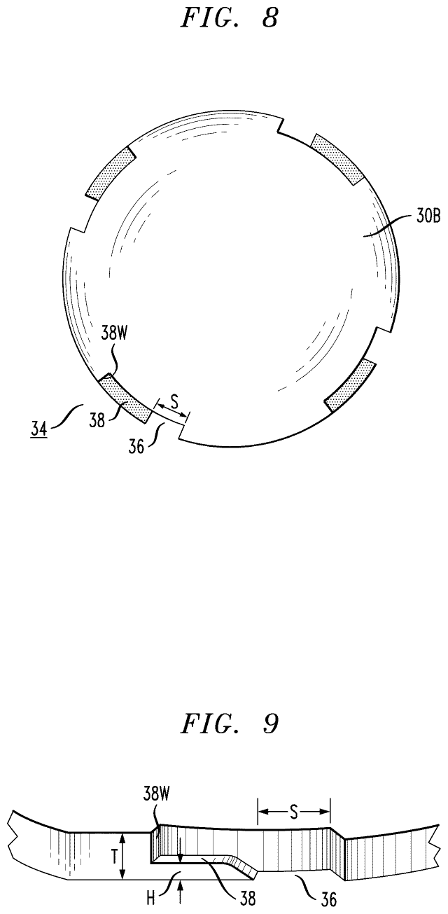

FIG. 9 is an isometric view of a portion of heat diffuser element 30B (not to scale) showing an example of a thickness T of element 30B, as compared to notched-out height H of ledge 38. Also shown in this particular example is a ramp-like end portion 39 of ledge 38, where this incline may facilitate the movement of the nub onto ledge 38.

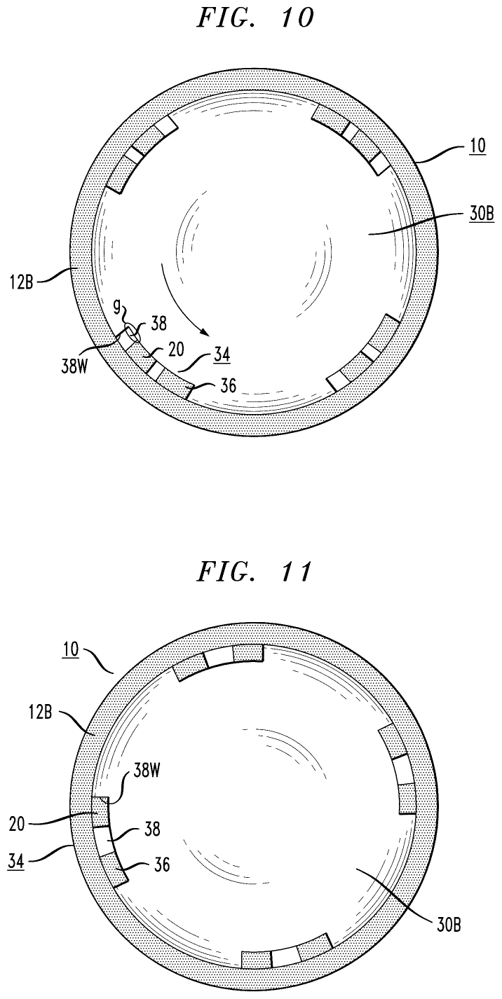

FIG. 10 shows heat diffuser element 30B in place over bottom surface 12B of cast iron pan 10. In this view, heat diffuser element 30B has been slightly rotated with respect to cast iron pan 10, with nubs 20 resting on ledges 38 of notched attachment areas 34. The view of FIG. 10 is considered as being only a partial rotation of heat diffuser element 30B, as evidenced by the remaining gap “g” between vertical wall 38W and nub 20. FIG. 11 illustrates a final, “locked” position of heat diffuser element 30B with respect to bottom surface 12B of cast iron pan 10. In this view, nubs 20 are shown as positioned fully against vertical walls 38W of ledges 38.

The use of cut-outs and L-shaped nubs make take many forms and is contemplated as only one type of releasable mechanism for joining the inventive diffuser element to a bottom surface of a cast iron pan. For example, the topology of the bottom surface of the pan may dictate a particular type of arrangement that may be preferred over another. That is, a relatively rectangular bottom surface of a griddle may use a differently-shaped diffuser element that is attach with another type of mechanism.

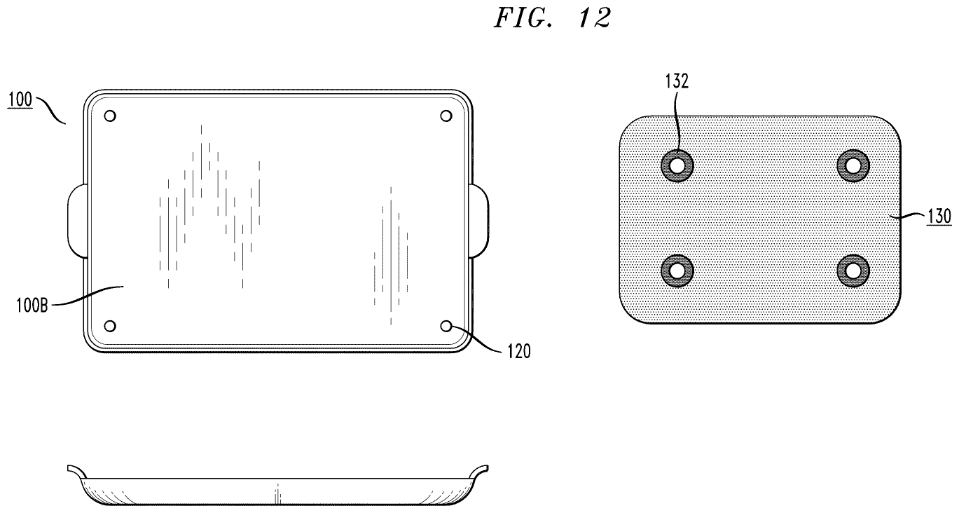

FIG. 12 illustrates a cast iron griddle 100 and associated heat diffuser element 130. In this view, a bottom surface 100B of griddle 100 is shown as being essentially rectangular. Thus, in order to best provide uniform heating of the cooking surface, heat diffuser element 130 is also rectangular in form. A releasable mechanism used in this example takes the form of threads 120 that are formed within bottom surface 100B of cast iron griddle 100. These threads 120 may be formed during the casting process in a well-known manner. A set of threaded openings 132 is formed through the thickness of heat diffuser element 130 and positioned to align with threads 120 of griddle 100 when heat diffuser element is positioned over bottom surface 100B of griddle 100. A set of screws (not shown in this view) may then be used to provide the releasable attachment between cast iron griddle 100 and heat diffuser element 130.

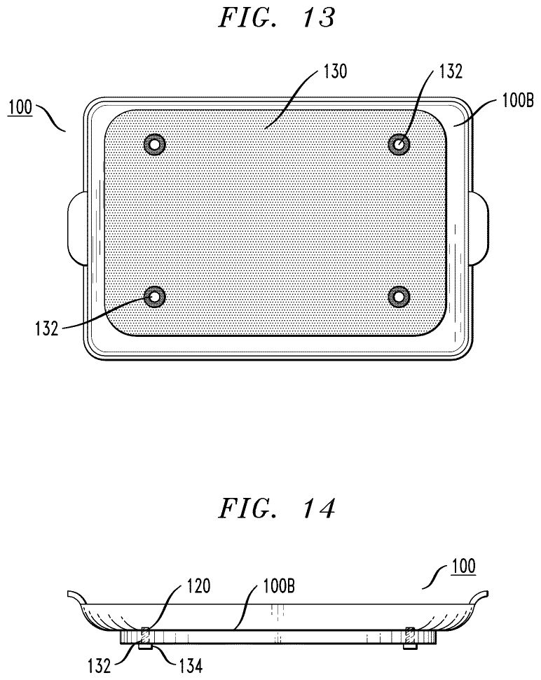

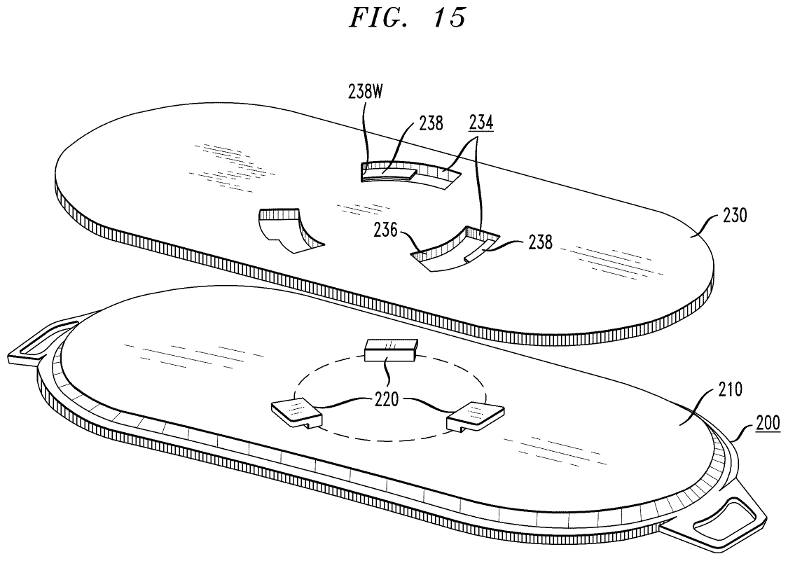

FIG. 13 illustrates heat diffuser element 130 in position on bottom surface 100B of griddle 100, with threaded openings 132 aligned with the underlying threads 120. FIG. 14 is a side view of the arrangement of FIG. 13, illustrating in particular the combination of threads 120 and threaded openings 132. Here, a set of screws 134 is shown as used to releasably attach heat diffuser element 130 to griddle 100.

While the griddle embodiment as shown in FIGS. 12-14 utilizes a releasable attachment mechanism in the form of screws and threads, it is to be understood that a releasable mechanism similar to that described above in association with FIGS. 1-11 may also be used with a rectangular (griddle) type of cookware. FIGS. 15-17 illustrate an example of this configuration.

FIG. 15 is an isometric view of a cast iron griddle 200 and an associated

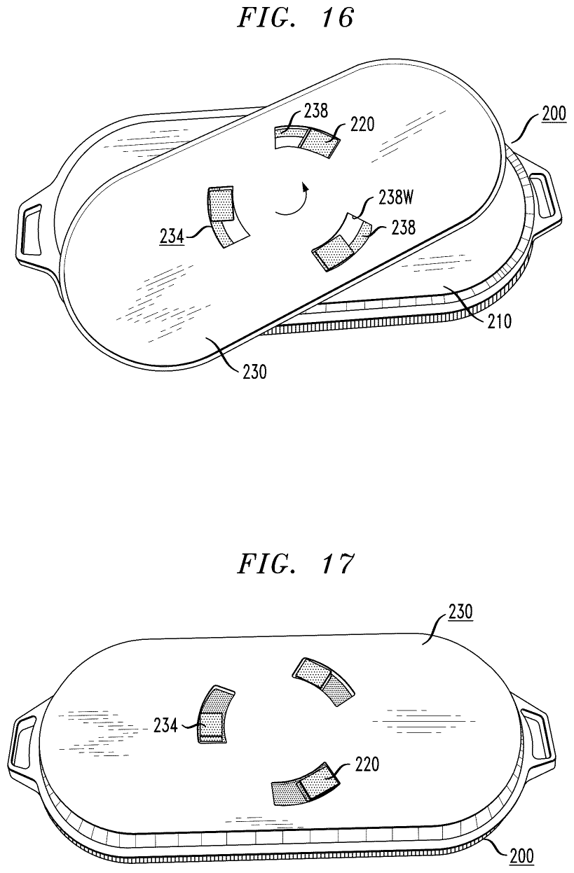

heat diffuser element 230. The view of FIG. 15 is an isometric, exploded view of a bottom surface 210 of griddle 200, with heat diffuser element 230 disposed over bottom surface 210. A plurality of L-shaped nubs 220 is shown as formed on bottom surface 210 (and may be integral cast iron features formed during the casting process for the griddle itself). In this embodiment, L-shaped nubs 220 are shown as formed within an interior region of bottom surface 210 (as opposed to around the periphery of the surface, as shown in the above example of a fry pan). L-shaped nubs 220 are positioned in a radial, spaced-apart arrangement (i.e., forming a circular pattern), as best evident in the views of FIGS. 16 and 17. The radial disposition of L-shaped nubs 220 allows for releasable attachment to be affected by rotating heat diffuser element 230 with respect to cast iron griddle 200.

Heat diffuser element 230 is shown as including a set of notched attachment areas 234 which are disposed to align with (and engage) L-shaped nubs 220 to provide releasable attachment to griddle 200 in accordance with the principles of the present invention. Thus, in contrast to the arrangements described above, notched attachment areas 234 are disposed in an interior region of the surface area of diffuser element 230. It is to be noted that the fry pan embodiments may use such an interior placement of nubs and engaging notches as well.

With continued reference to FIG. 15, each notched attachment area 234 is formed to include a cut-out 236 that are sized to exhibit a width slightly greater than the width of a nub as formed on the pan. Additionally, adjacent to each cut-out 236 is an extended ledge 238 that is notched out of the total thickness of heat diffuser element 230. Ledge 238 is shown as terminating at a vertical wall 238W.

FIG. 16 illustrates heat diffuser element 230 in an initial placement position over bottom surface 210 of cast iron griddle 200. In this initial placement, L-shaped nubs 220 are shown as exposed through mating cut-outs 236 formed through the thickness of heat diffuser element 230. Once the initial placement is performed, heat diffuser element 230 may then be rotated (as indicated by the arrow), resulting in the final configuration as shown in FIG. 17. As with the embodiments described above, in the final “locked” position, L-shaped nubs 220 engage with associated ledges 238 within cut-outs 234 such that diffuser element 230 remains firmly in place against bottom surface 210.

The attachment is considered as releasable, since heat diffuser element 230 may be removed simply by rotating the element in the opposite direction so that L-shaped nubs 220 again align with cut-outs 236.

Summarizing, in accordance with the principles of the present invention, the proposed heat diffuser causes the concentrated heat of a conventional electric or gas burner to rapidly diffuse, transmitting heat evenly across the bottom surface (and thus into the interior cooking surface) of cast iron cookware. The inclusion of this heat diffuser element may be considered to mimic the essentially even cooking surface temperature of traditional wide-area wood or coal-fired cook stoves.

Although the invention has been described in detail for the purposes of illustration based on what is currently considered to be the most practical and preferred embodiments or aspects, it is to be understood that such detail is solely for that purpose and the invention, as a whole, is not so limited. Those skilled in the art will appreciate that various adaptations and modifications of the described embodiments can be configured without departing from the spirit and scope of the invention as defined by the claims appended hereto.

What is claimed is:

1. Cookware, comprising:
a cast iron cooking surface of a defined surface area geometry, the cast iron cooking surface defined as having an inner, cooking side and an outer, heating side;
a releasable attachment mechanism disposed on the outer, heating side of the cast iron cooking surface; and
a heat diffuser element coupled to the outer, heating side of the cast iron cooking surface by the releasable attachment mechanism, the heat diffuser element configured to exhibit a topology similar to the outer, heating side of the cast iron cooking surface and formed of a composition comprising a rate of thermal diffusivity greater than thermal diffusivity of cast iron.

2. Cookware as defined in claim 1, wherein the heat diffuser element comprises a single material with a rate of thermal diffusivity greater than the thermal diffusivity of cast iron.

3. Cookware as defined in claim 1, wherein the heat diffuser element comprises at least one material selected from the group consisting of: copper, aluminum, and carbon.

4. Cookware as defined in claim 1, wherein the cast iron cooking surface is configured as an essentially round surface, the heat diffuser element configured as a round plate of a thickness T and a diameter substantially the same as the cast iron cooking surface.

5. Cookware as defined in claim 4, wherein the releasable attachment mechanism comprises a plurality of L-shaped nubs disposed at spaced-apart locations on the outer, heating side of the cast iron cooking surface.

6. Cookware as defined in claim 5, wherein
the heat diffuser element includes a plurality of notches positioned and sized to align with the plurality of L-shaped nubs upon placement of the heat diffuser element against the outer, heating side of the cast iron cooking surface, the heat diffuser element capable of being rotated such that the plurality of L-shaped nubs thereafter rest against a portion of the heat diffuser material so as to releasably attach the heat diffuser element to the cookware.

7. Cookware as defined in claim 6, wherein the heat diffuser element further comprises a plurality of ledges, disposed adjacent to the plurality of notches in a one-to-one relationship such that as the heat diffuser element is rotated with respect to the cast iron cooking surface, the L-shaped nubs pass over the ledges to facilitate movement into a final attachment position.

8. Cookware as defined in claim 7 wherein each ledge includes a tapered ramp end at a location where the L-shaped nub first passes over the ledge.

9. Cookware as defined in claim 4 wherein the plurality of L-shaped nubs are disposed around the periphery of the outer, heating side of the cast iron cooking surface.

10. Cookware as defined in claim 1 wherein cast iron cooking surface is configured as an essentially rectangular surface, the heat diffuser element configured as a rectangular plate of a thickness T and dimensions substantially the same as the cast iron cooking surface.

11. Cookware as defined in claim 10 wherein the releasable attachment mechanism comprises a plurality of threaded openings formed in the outer, heating side of the cast iron cooking surface, the heat diffuser element including a plurality of openings disposed to align with the plurality of threaded openings upon placement of the heat diffuser element against the outer, heating side of the cast iron cooking surface, allowing for a plurality of screws to be used to releasably attach the heat diffuser element to the outer, heating side of the cast iron cooking surface.

12. Cookware as defined in claim 10 wherein the releasable attachment mechanism comprises
a plurality of L-shaped nubs disposed at radially spaced-apart locations on the outer, heating side of the cast iron cooking surface; and
a plurality of notches disposed through the thickness of the heat diffuser element in a radially spaced-apart pattern that aligns with the plurality of L-shaped nubs upon placement of the heat diffuser element against the outer, heating side of the cast iron cooking surface, the heat diffuser element capable of being rotated such that the plurality of L-shaped nubs thereafter rest against a portion of the heat diffuser material so as to releasably attach the heat diffuser element to the cookware.

13. Cookware as defined in claim 1 wherein the heat diffuser element comprises at least two different materials, a first material exhibiting a first rate of thermal diffusivity disposed in a central region of the heat diffuser element, and a second material exhibiting a second rate of thermal diffusivity disposed to surround the central region.

14. Cookware as defined in claim 13 wherein the first rate of thermal diffusivity is greater than the second rate of thermal diffusivity.

15. Cookware as defined in claim 14 wherein the first material comprises copper and the second material comprises aluminum.

16. Cookware as defined in claim 1 wherein the cast iron cooking surface comprises a cast iron pan cooking surface of essentially rounded form.

17. Cookware as defined in claim 1 wherein the cast iron cooking surface comprises a cast iron griddle cooking surface of essentially rectangular form.
